(19) United States
(12) Patent Application Publication
(10) Pub. No.: US 2019/0057603 A1
(43) Pub. Date: Feb. 21, 2019

(54) SYSTEM FOR OBJECT ACQUISITION ON SURFACES, IN PARTICULAR PARKING AREAS

(71) Applicant: Gauff Telematics GmbH, Mendig (DE)

(72) Inventors: Michael Maurer, Mendig (DE); Thorsten Schneider, Mendig (DE)

(21) Appl. No.: 16/102,334

(22) Filed: Aug. 13, 2018

(30) Foreign Application Priority Data
Aug. 16, 2017 (DE) 202017104922.1
Aug. 16, 2017 (EP) 17186469.7

(51) Int. Cl. G08G 1/065; G06K 9/00; G01S 17/06

(52) U.S. Cl. CPC G08G 1/065; G01S 17/06; G06K 9/00825; G06K 9/00812

(57) ABSTRACT

An object acquisition system is provided for acquiring objects, for example, trucks, passenger automobiles, buses, etc. on large surfaces, such as parking areas. The system comprises an acquisition device having a fastening unit for fastening the data acquisition unit on a fastening object, a pivot motorconnected to the fastening unit, a pivot arm, which is coupled at one end to the pivot motor such that the pivot arm is pivotable by means of the pivot motor about an axis of rotation, a control unit for controlling the pivot motor, and a data acquisition unit for acquiring object information, wherein the data acquisition unit is attached spaced apart from the axis of rotation on the pivot arm. Furthermore, the system comprises a computation unit for computing a 3D dataset from the data of the data acquisition unit and data with respect to the movement of the pivot motor.

### TECHNICAL FIELD

The present disclosure relates to an object acquisition system, which can be used to acquire objects, for example, trucks, on a surface or large surface, for example, on a parking area.

### BACKGROUND

In conventional systems for monitoring large surfaces, on which movable objects, for example, trucks, automobiles, containers, or the like are temporarily located, to determine whether sufficient space for further objects is still available on the surface, in general the entries and exits are monitored, as will be described hereafter by way of example with reference to a truck parking area.

In the case of a truck parking area on a freeway, for example, the number of the incoming trucks and the length thereof would be monitored at the entrance. In addition, the number of the outgoing trucks would be monitored at the exit. By addition or subtraction of the incoming or outgoing trucks, respectively, the free capacity of the area could be determined.

### BRIEF SUMMARY

Such a conventional system has to be calibrated at certain intervals, however, to ensure a reliable acquisition of the free capacities even over a longer period of time. For this purpose, camera images of the entire parking area are analysed manually, to calibrate the present number of parking vehicles. In addition to an additional hardware usage, this requires a significant personnel usage, which causes additional costs.

It would therefore be desirable to provide an object acquisition system, in particular for monitoring parking areas and other large surfaces, which enables reliable detection of arbitrarily positioned objects with little hardware and personnel usage.

An object acquisition system according to a first aspect comprises an acquisition device and a computation unit. The acquisition device has in this case a fastening unit, a pivot motor, for example, a stepping motor or servo motor, a pivot arm, a control unit, and a data acquisition unit.

With the aid of the fastening unit, the acquisition device can be attached to a fastening object, for example, a substantially vertical surface. The fastening object can be, for example, a mast or post.

The pivot motor, which can be designed, for example, as a stepping motor or servo motor, is connected in this case to the fastening unit, for example, by means of the housing.

The pivot arm is in turn coupled to the pivot motor such that the pivot arm is pivotable about an axis of rotation by means of the pivot motor. This can take place, for example, by direct or indirect coupling of the axis of the pivot motor to the pivot arm with or without interconnected gearing.

The data acquisition unit is attached spaced apart from the axis of rotation, for example, of the coupling point of an axis connected to the pivot motor on the pivot arm. For example, the data acquisition unit can be attached at the other end of the pivot arm in relation to the centre point of the pivot arm. The spacing enables the data acquisition unit to be rotated at a spacing defined by the spacing along the pivot arm about the fastening unit, for example, the mast or the like, using the pivot motor by controlling the pivot motor by means of the control unit.

The entire region around the fastening object (for example, post or mast) can be acquired by the rotation of the data acquisition unit by means of the pivot arm, without a shadow resulting due to the mast.

This enables the computation unit to compute a 3D dataset from the data of the data acquisition unit and data with respect to the movement of the pivot motor.

This arrangement therefore enables a 360° acquisition of all objects around the fastening object using only one data acquisition unit.

The system is therefore cost-effective, since only one data acquisition unit is required. A manual calibration of the system is also dispensed with, since the complete surface is acquired by the data acquisition unit, and not only, for example, the entries and exits, as in the known systems.

The described system also enables the arrangement of the acquisition device at an arbitrary height, for example, on an already existing mast on a parking area. Conventional data acquisition units could not be arranged on these masts in this manner without a shadow resulting. They would always have to be arranged at the tip of the mast, whereby an optimum alignment of the system in height would not be possible.

According to a further aspect, the object acquisition system is designed for acquiring objects on a surface, in particular a large surface.

The system can accordingly be used for monitoring surfaces or large surfaces such as parking areas, container transhipment centres, harbours, or the like.

According to a further aspect, the fastening unit is designed for fastening the data acquisition unit on a substantially vertical surface (fastening surface), and the data acquisition unit is attached to the pivot arm such that an acquisition region of the data acquisition unit is aligned parallel to the axis of rotation, and in particular in the direction of a surface or large surface to be monitored.

The data acquisition unit can accordingly be installed on a vertical surface, such as the surface of a mast, etc. Furthermore, an acquisition of a 360° region around the fastening object is ensured by the alignment of the acquisition region parallel to the axis of rotation.

The acquisition region is to be understood in this case, for example, as the viewing angle of a camera or the scanning region of a laser scanner. Accordingly, the coverage of an axis parallel to the axis of rotation by the acquisition region is to be understood as an alignment of the acquisition region parallel to the axis of rotation and, according to a refining aspect, as the alignment of the main axis, for example, the centre of a camera parallel to the axis of rotation.

According to a further aspect, the data acquisition unit is designed as a laser scanner, in particular as a 2D laser scanner.

This enables reliable detection even in bad weather and/or light conditions, and also is usable in the case of complete darkness.

According to a further aspect, the 2D laser scanner is connected to the pivot arm such that a 2D acquisition region of the 2D laser scanner is aligned substantially perpendicularly to the longitudinal axis of the pivot arm and parallel to the axis of rotation.

A coverage without shadows in spite of the use of only one 2D laser scanner is ensured by this alignment.

Although only one 2D scanner is used, a 360° acquisition can take place, without shadows due to the mast or post.

Moreover, the above-described arrangement enables the use of a 2D laser scanner to acquire a three-dimensional image. The 2D laser scanners have substantially enhanced resolution in relation to the use of 3D laser scanners which are presently commercially available.

According to a further aspect, the object acquisition system furthermore has a data processing unit, which is designed for computing the position and/or the dimensions of objects based on the 3D dataset, computed by the computation unit.

Therefore, dimensions and positions of objects, such as trucks, can be acquired based on the acquired data.

According to a further aspect, the data processing unit is furthermore designed to determine free regions between the acquired objects and the dimensions thereof based on the 3D dataset, computed by the computation unit.

Therefore, free regions, such as free parking spaces on a parking area or free container placement areas, can be computed from the data.

According to a further aspect, the system furthermore comprises a transmitting unit for transmitting information with respect to the free regions to at least one mobile unit.

This enables the users of the system, for example, truck drivers, to be informed about the present parking area situation via mobile telephones, navigation devices, or the like. According to one aspect, the object acquisition system furthermore comprises the at least one mobile unit. The mobile unit in turn comprises a receiving unit and a data display unit and is designed to receive information from the transmitting unit by means of the receiving unit and to output information based on the received information with respect to the free regions to a user via the data display unit.

This enables users of the system, for example, truck drivers, to be informed about the present parking area situation via mobile telephones, navigation devices, or the like.

According to a further aspect, a surface to be monitored is either a parking area, a container transhipment centre, or a harbour and the objects are trucks, passenger automobiles, buses, containers, and/or ships.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 shows an object acquisition system according to one aspect.

FIG. 2 shows a vertical view of the acquisition device of the object aquisition system.

FIGS. 3A and 3B show an acquisition procedure by means of the object acquisition system.

### DETAILED DESCRIPTION OF EXEMPLARY EMBODIMENTS

The illustrations in the figures are schematic and are not to scale.

If identical reference signs are used in the following description of exemplary embodiments in various figures, they thus indicate identical or similar elements. Identical or similar elements can also be identified by different reference signs, however.

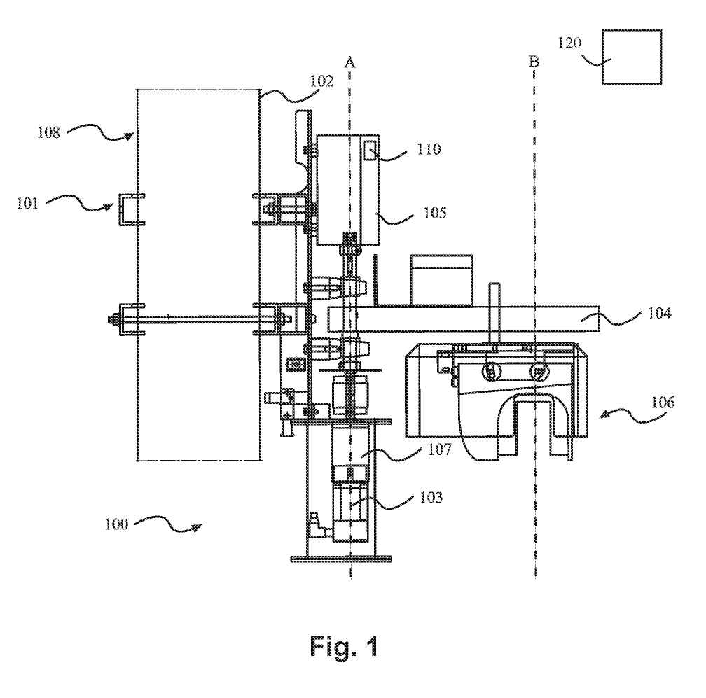

FIG. 1 shows an object acquisition system according to one embodiment of the present disclosure. The object acquisition system includes an acquisition device 100 and a computation unit 120.

The acquisition device 100 has in this case a fastening unit 101, a pivot motor 103, a pivot arm 104, a control unit 110, and a data acquisition unit 106.

The fastening unit 101 is designed in this case according to one aspect such that it is suitable for fastening on a substantially vertical surface (fastening surface) 102, for example, a mast or a post 108. It can be designed, for example, as one or more screw clamps, clamps, or screw connection devices for the screw connection to a fastening surface.

The housing of the pivot motor 103 is connected to the fastening unit 101 in the present example.

This pivot motor 103 is coupled with its axis to one end of the pivot arm 104.

For this purpose, either an axis of the pivot motor can be directly coupled to the pivot arm, or a gearing 107 or further components, for example, such as axes, etc. can be interconnected, to achieve a coupling in this way.

As can be inferred from FIG. 1, an axis of rotation A, about which the pivot arm is pivoted, is preferably substantially parallel to the surface to which the fastening unit 101 is connected. Therefore, the pivot arm preferably pivots in a plane which is perpendicular to the axis of rotation and therefore perpendicular to the surface.

The data acquisition unit 106 is connected to the pivot arm 104 spaced apart from the axis of rotation A, in other words, the data acquisition unit 106 is arranged on a side of the pivot arm 104 facing away from the axis of rotation and the pivot motor.

By way of this arrangement, the data acquisition unit 106 can be rotated on the pivot arm 104 by means of the pivot motor 103 about the axis of rotation A.

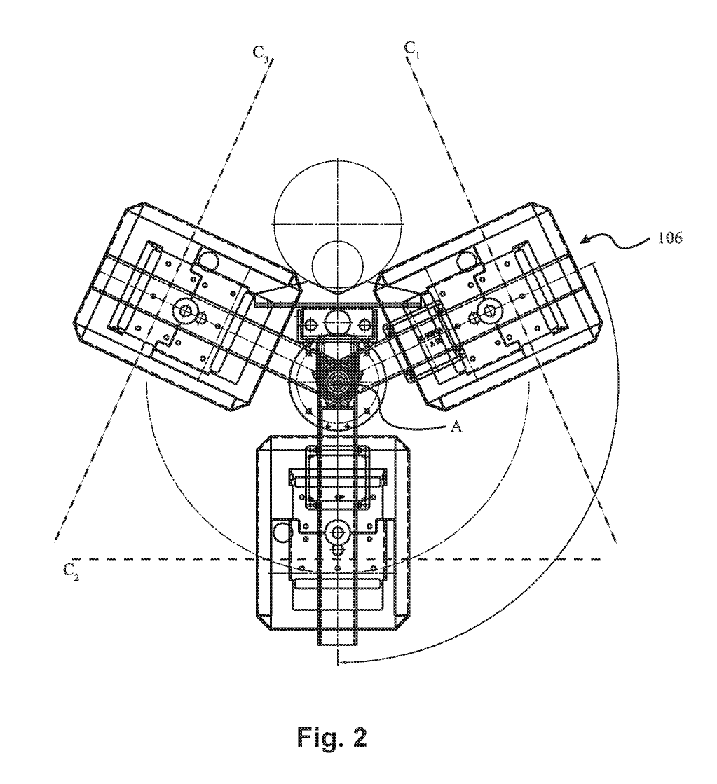

Such pivoting is shown in FIG. 2. Three states can be recognized in this case, in which the data acquisition unit 106 is shown once in maximum rotation in each of the two pivot directions, and also once in the middle position.

The spacing between data acquisition unit 106 and axis of rotation A and also the maximum rotational angle, for example, pivot angle in each direction can be adapted suitably to the dimensions of the fastening object, for example, the mast or post 108.

As can again be inferred from FIG. 1, a data acquisition region, i.e., a region in which the data acquisition unit 106 records data, is aligned in the present example in the direction of the axis of rotation A.

This will be described in greater detail on the basis of a 2D laser scanner with reference to FIG. 1.

A 2D laser scanner, also referred to as LiDAR, emits laser pulses and computes the distance to obstructions from the reflections. These laser pulses are output in a plane having a predefined angle resolution over the aperture angle of the LiDAR. For example, scanning is performed over an aperture angle of 190°, and therefore data on the distance of measurement points in a plane (referred to hereafter as the data acquisition plane) are available over an angle of 190° (depending on the laser scanner used) as the data output of the 2D laser scanner.

The data acquisition plane is identified with B in FIG. 1. It is substantially parallel to the axis of rotation A here.

If the data acquisition unit 106 is pivoted with the aid of the pivot arm about the axis of rotation A, the data acquisition plane thus moves such that the entire surface, in addition to a region located behind a fastening object having the fastening surface or a substantially vertical surface 102, can be successively acquired by the data acquisition unit 106.

This is shown in FIG. 2, which shows the 2D acquisition region of the laser scanner in the respective pivot or rotation state as dashed lines, respectively identified with C1 to C3. The region behind the fastening object can also be reliably acquired, as is evident.

The control of the pivot motor takes place for this purpose by way of a control unit 110, which outputs suitable control signals to the pivot motor.

The data output by the data acquisition unit 106 during the pivot procedure can now be used together with information about the present position of the pivot motor (and therefore the pivot arm) to compute a 3D image, preferably a 360° image.

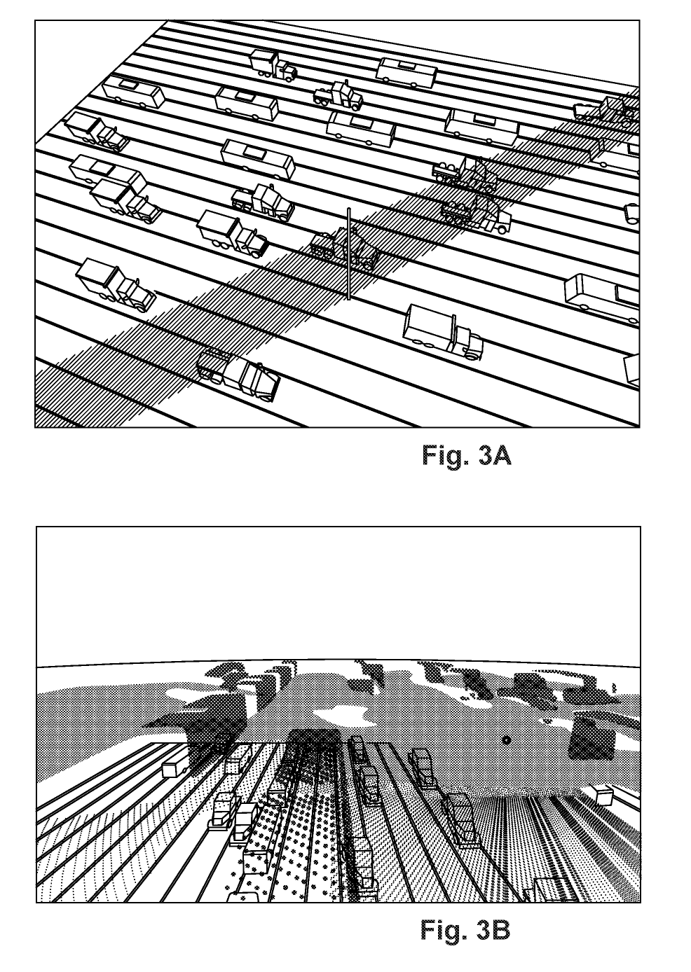

A result of such a pivot procedure is shown in FIGS. 3A and 3B.

FIGS. 3A and 3B show the acquisition of objects on a surface, wherein the acquisition of trucks on a parking area is shown by way of example.

In accordance with the above description, the acquisition device 100 comprising the data acquisition unit 106 is installed on a mast and the acquisition region, which is shown as a dotted surface, is aligned parallel to the axis of rotation and in the direction of the surface to be monitored.

After a rotation of the laser scanner by means of the pivot motor, the computation unit 120 can now compile the measurement points which are output by the data acquisition unit 106. For this purpose, in addition to the data of the data acquisition unit 106, data on the position of the pivot motor 103 can be used. Such data can be achieved, on the one hand, by the control unit 110 or, on the other hand, by the pivot motor itself, or in another manner for example, by calibration by means of external points.

The point cloud of measurement points over the entire surface shown in FIG. 3B results due to the compilation of the measurement points by the computation unit 120.

As is apparent, an acquisition of a complete 360° region without shadows due to the mast can be carried out.

In one embodiment, the object acquisition system furthermore comprises a data processing unit. For example, the data processing unit may be incorporated with the control unit 110 as in the implementation shown in FIG. 1, or may be separately located in the electronics box 105. The data processing unit is configured in this case to compute the position and/or dimensions of acquired objects, for example, acquired trucks, by means of the 3D dataset computed by the computation unit 120.

Furthermore, the data processing unit can preferably be designed for the purpose of extracting regions which are not occupied by objects from the 3D dataset, and also preferably determining the dimensions and/or position of the free regions.

Thus, for example, free parking spaces for trucks or passenger automobiles on a parking area, free positioning spaces for containers in a container harbour, or free berths in a harbour can be determined.

Data of the data processing unit can furthermore preferably be transmitted by means of a transmission unit (not shown) to terminals (not shown).

Users of the system can be informed about a present occupancy of the surface by means of the terminals, which can have, for example, a display screen as a data display unit. The term “unit” is not to be understood as restricted to a physical unit in the preceding description. The above-mentioned units such as the control unit 110, data acquisition unit 106, and computation unit 120 can also be, for example, software or routines which can be implemented on a common chip or also distributed over multiple chips or computers.

The control unit 110, the data acquisition unit 106, and/or the computation unit 120 can be provided, for example, in the electronics box 105. However, all or some of the components can also be provided in external devices, which can be connected, for example, via radio or in a wired manner. In the example shown, the control unit 110 is provided in the electronics box, and the computation unit 120 is an external device wirelessly connected to the data acquisition unit 106 and optionally the control unit 110.

In addition, it is to be noted that “comprising” and “having” does not preclude other elements or steps and “a” or “an” does not preclude a plurality. Furthermore, it is to be noted that features or steps which have been described with reference to one of the above exemplary embodiments can also be used in combination with other features or steps of other above-described exemplary embodiments. Reference signs in the claims are not to be considered to be a restriction.

The Abstract of the disclosure is solely for providing a way by which to determine quickly from a cursory reading the nature and gist of technical disclosure, and it represents solely one or more embodiments.

The embodiments set forth herein are merely illustrative and do not limit the scope of the disclosure or the details therein. It will be appreciated that many other modifications and improvements to the disclosure herein may be made without departing from the scope of the disclosure or the inventive concepts herein disclosed. Because many varying and different embodiments may be made within the scope of the inventive concept herein taught, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

1. An object acquisition system for acquiring objects, comprising:
an acquisition device having
a fastening unit for fastening the data acquisition unit on a fastening object;
a pivot motor, wherein the pivot motor is connected to the fastening unit;
a pivot arm, which is coupled at one end to the pivot motor such that the pivot arm is pivotable by means of the pivot motor about an axis of rotation;
a control unit for controlling the pivot motor; and
a data acquisition unit for acquiring object information, wherein the data acquisition unit is attached to the pivot arm spaced apart from the axis of rotation; and
a computation unit for computing a 3D dataset from the data of the data acquisition unit and data with respect to the movement of the pivot motor.

2. The object acquisition system according to claim 1, wherein the object acquisition system is designed for acquiring objects on a surface, in particular a large surface.

3. The object acquisition system according to claim 1, wherein:
the fastening unit is designed for fastening the data acquisition unit on a substantially vertical surface; and
the data acquisition unit is attached to the pivot arm such that an acquisition region of the data acquisition unit is aligned parallel to the axis of rotation, and in particular in the direction of a surface or large surface to be monitored.

4. The object acquisition system according to claim 1, wherein the data acquisition unit is a laser scanner.

5. The object acquisition system according to claim 1, wherein the data acquisition unit is a 2D laser scanner.

6. The object acquisition system according to claim 5, wherein:
the 2D laser scanner is connected to the pivot arm in such a way that a 2D acquisition region of the 2D laser scanner is aligned substantially perpendicular to the longitudinal axis of the pivot arm and parallel to the axis of rotation.

7. The object acquisition system according to claim 1, further comprising:
a data processing unit for computing the position and/or the dimensions of objects based on the 3D dataset, computed by the computation unit.

8. The object acquisition system according to claim 7, wherein:
the data processing unit is designed to determine free regions between the acquired objects and the dimensions thereof based on the 3D dataset, computed by the computation unit.

9. The object acquisition system according to claim 1, further comprising:
a transmitting unit for transmitting information with respect to the free regions to at least one mobile unit.

10. The object acquisition system according to claim 9, wherein:
the mobile unit has a receiving unit and a data display unit and is designed to receive information from the transmitting unit by means of the receiving unit and to output information based on the received information with respect to the free regions to a user via the data display unit.

11. The object acquisition system according to claim 1, wherein:
a surface to be monitored is at least one of:
a parking area;
a container transhipment centre; or
a harbour; and
the objects are at least one of:
trucks;
passenger automobiles;
buses;
containers; or
ships.
